(19) United States
(12) Patent Application Publication
(10) Pub. No.: US 2016/0367942 A1
(43) Pub. Date: Dec. 22, 2016

(54) POST-PROCESSING SYSTEM OF DIESEL VEHICLE FOR REDUCING H2S

(71) Applicant: HYUNDAI MOTOR COMPANY, Seoul (KR)

(72) Inventors: Jin Ha LEE, Seoul (KR); Won Soon PARK, Seongnam-si (KR); Seong Ho YOO, Ansan-si (KR); Myung Jong LEE, Ansan-si (KR)

(73) Assignee: HYUNDAI MOTOR COMPANY, Seoul (KR)

(21) Appl. No.: 14/860,957

(22) Filed: Sep. 22, 2015

(30) Foreign Application Priority Data
Jun. 16, 2015 (KR) 10-2015-0085082

(51) Int. Cl. B01D 53/94

(52) U.S. Cl. CPC B01D 53/9477; B01D 2255/2073; B01D 2255/2092; B01D 2255/1021; B01D 2255/1023

(57) ABSTRACT

The present disclosed provides a post-processing system of a diesel vehicle in which an LNT catalyst and a DPF are sequentially disposed on an exhaust gas channel of the engine. The post-processing system includes: an LNT catalyst configured to adsorb nitrogen oxide (NOₓ) under lean atmosphere and desorb the nitrogen oxide (NOₓ) under rich atmosphere, based on a window of theoretical air-fuel ratio; and a diesel particulate filter (DPF). The DPF includes a first purifier disposed at a back end of the LNT catalyst and purifying hydrocarbon (HC) and carbon monoxide (CO), and a second purifier disposed at a back end of the first purifier and purifying hydrogen sulfide (H₂S).

### CROSS-REFERENCE TO RELATED APPLICATION

This application claims the benefit of Korean Patent Application No. 10-2015-0085082, filed on Jun. 16, 2015, which is incorporated herein by reference in its entirety.

### FIELD

The present disclosure relate to a post-processing system of a diesel vehicle capable of reducing an emission.

### BACKGROUND

The statements in this section merely provide background information related to the present disclosure and may not constitute prior art.

The present disclosure relates to a post-processing system of a diesel vehicle in which a lean NO trap catalyst (LNT catalyst) and a diesel particulate filter (DPF) are sequentially disposed, for reducing an emission of H₂S at the time of a regeneration of LNT catalyst and easily removing particulate matters of a diesel particulate filter (DPF) at a low temperature.

Generally, exhaust gas emitted from an engine through an exhaust manifold is induced into and purified in a catalytic converter installed in an exhaust pipe and is then emitted into the atmosphere through a tail pipe, having attenuated noise by passing through a muffler.

The catalytic converter purifies pollutants included in the exhaust gas. Further, the exhaust pipe is provided with a soot filter for collecting particulate matters (PM) included in the exhaust gas.

A denitrification catalyst (DeNOₓ catalyst) is a type of catalytic converter which purifies nitrogen oxide (NOₓ) included in the exhaust gas. When reducing agents such as urea, ammonia, carbon monoxide, and hydrocarbon (HC) are offered to the exhaust gas, the denitrification catalyst reduces the nitrogen oxide included in the exhaust gas by an oxidation-reduction reaction with the reducing agents.

Among the denitrification catalysts, a lean NOₓ trap catalyst (LNT catalyst) adsorbs the nitrogen oxide included in the exhaust gas when the engine is operated under the lean atmosphere and desorbs the adsorbed nitrogen oxide when the engine is operated under the rich atmosphere. In this case, the lean NOₓ trap catalyst is poisoned by a sulfur (S) component included in fuel and a lubricant after the vehicle is driven for a long period of time and thus the performance thereof is degraded.

As a result, desulfurization regeneration for removing the poisoned sulfur component every predetermined period needs to be performed. Here, the desulfurization regeneration removes the sulfur (S) having the LNT catalyst poisoned, using a high-temperature rich control of the engine.

In this case, the hydrogen sulfide (H₂S) which is colorless poisonous gas with odor is generated until the sulfur S is desorbed. Therefore, there is a need to remove the hydrogen sulfide (H₂S) which is generated during the regeneration of the LNT catalyst by desulfurizing the hydrogen sulfide.

The existing method for desulfurizing which after a nitrogen oxide absorbing catalyst is continuously poisoned by the sulfur components in the exhaust gas, regenerate a diesel particulate filter (DPF) and then continuously perform desulfurization is known in detail in a desulfurization method for an LNT system of a related art.

However, we have discovered that the existing method may not appropriately perform the regeneration control depending on the poisoning and deterioration degree of the catalyst and has a limitation in the improvement in purification performance of harmful oxides.

Further, we have discovered that the existing method does not yet solve a problem that the hydrogen sulfide generated during the desulfurization process of removing the poisoned sulfur S is emitted into the atmosphere without being purified, and thus causes air pollution.

### SUMMARY

The present disclosure relates to a post-processing system of a diesel vehicle for reducing H₂S, which is capable of reducing hydrogen sulfide (H₂S) which is a factor of odor occurrence and easily removing particulate matters of a diesel particulate filter (DPF) at a low temperature.

In accordance with an embodiment of the present disclosure, a post-processing system of a diesel vehicle for reducing H₂S in which an LNT catalyst and a DPF are sequentially disposed from an engine on an exhaust gas channel of the engine, the post-processing system includes: an LNT catalyst configured to adsorb nitrogen oxide (NOₓ) under lean atmosphere and desorb the nitrogen oxide (NOₓ) under rich atmosphere, based on a window of theoretical air-fuel ratio; and a diesel particulate filter (DPF) configured to include a first purifier disposed at a back end of the LNT catalyst and purifying hydrocarbon (HC) and carbon monoxide (CO), and a second purifier disposed at a back end of the first purifier and purifying hydrogen sulfide (H₂S).

The diesel particulate filter may have a front surface coated with an oxidation catalyst coating layer including manganese (Mn) and aluminum (Al).

The oxidation catalyst coating layer may further include platinum (Pt).

The first purifier may further include a precious metal coating layer of which the front surface is coated with precious metal in which platinum (Pt) and palladium (Pd) are mixed at a weight ratio of 1:1.

The precious coating layer may be coated with the precious metal including the platinum (Pt) and the palladium (Pd) at approximately from 5 to 12 g/ft³.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating a post-processing system of a diesel vehicle for reducing H₂S according to an exemplary embodiment of the present disclosure;

FIG. 2 is a diagram for describing a diesel particulate filter (DPF) according to an exemplary embodiment of the present disclosure; and

FIG. 3 is a graph illustrating regeneration efficiency depending on temperature, for the existing diesel particulate filter and examples of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

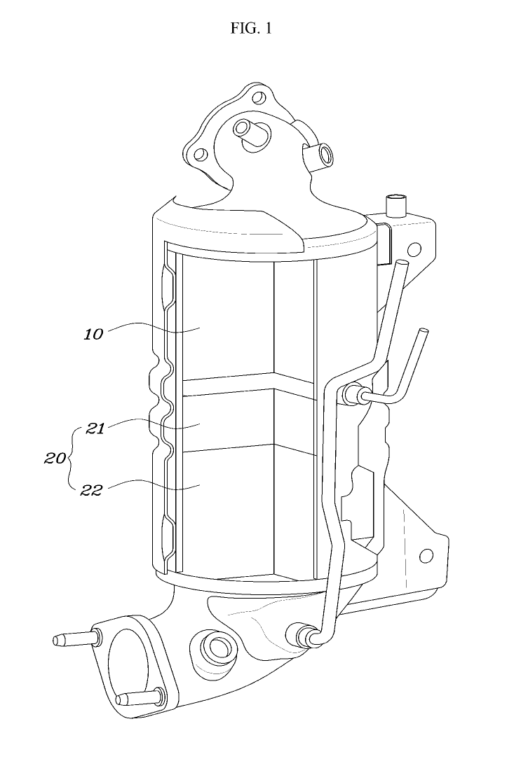

FIG. 1 is a diagram illustrating a post-processing system of a diesel vehicle for reducing H₂S according to an exemplary embodiment of the present disclosure.

As illustrated in FIG. 1, the post-processing system of a diesel vehicle for reducing H₂S is a post-processing of a diesel vehicle in which an LNT catalyst and a diesel particulate filter (DPF) are sequentially disposed in a flow direction of exhaust gas on an exhaust gas channel and includes an LNT catalyst 10 absorbing or desorbing nitrogen oxide (NOₓ) depending on operation conditions of an engine and a diesel particulate filter 20 including a first purifier 21 and a second purifier 22.

The LNT catalyst 10 according to the exemplary embodiment of the present disclosure absorbs the nitride oxide (NOₓ) under the lean atmosphere in which an air ratio is high based on a window of a theoretical air-fuel ratio and desorbs the nitrogen oxide (NOₓ) under the high rich atmosphere in which the ratio of fuel is high.

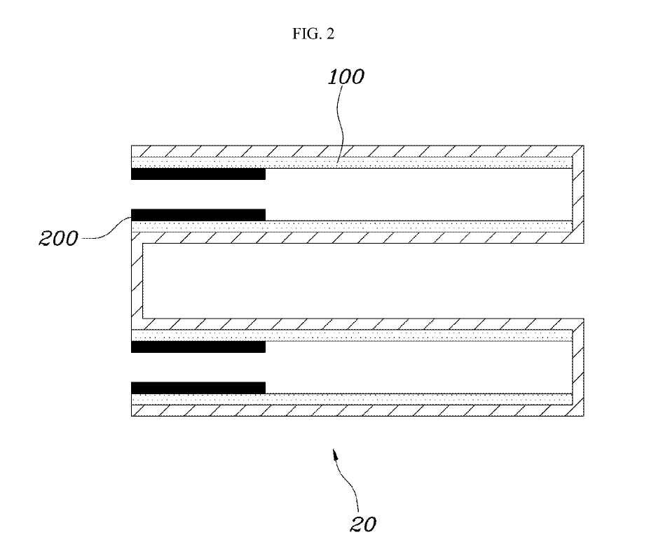

FIG. 2 is a diagram for describing a diesel particulate filter (DPF) according to an exemplary embodiment of the present disclosure.

As illustrated in FIG. 2, the diesel particulate filter 20 includes the first purifier 21 which purifies hydrocarbon (HC) and carbon monoxide (CO) and a second purifier 22 which is disposed at a back end of the first purifier 21 to desulfurize sulfur S poisoning the LNT catalyst 10 so as to purify hydrogen sulfide (H₂S) generated at the time of regeneration

A front surface of the diesel particulate filter 20 is provided with an oxidation catalyst coating layer 100 including manganese (Mn) and aluminum (Al). In one form according to the present disclosure, the diesel particulate filter 20 further includes platinum Pt.

Therefore, the oxidation catalyst coating layer 100 according to the exemplary embodiment of the present disclosure may more improve the purification performance of hydrogen sulfide (H₂S) than the existing coating layer made of copper (Cu) and aluminum (Al). Further, the oxidation catalyst coating layer 100 according to the exemplary embodiment of the present disclosure may further include platinum (Pt) to improve the oxidation efficiency of particulate matters (soot).

According to the exemplary embodiment of the present disclosure, the first purifier 21 which is disposed at a back end of the LNT catalyst 10 may further include a precious metal coating layer 200 coated with precious metal in which platinum (Pt) and palladium (Pd) are mixed at a weight ratio of 1:1.

By doing so, it improves the performance of removing the particulate matters (soot) at a low temperature less than 600° C.

In this case, the precious metal coating layer 200 according to the exemplary embodiment of the present disclosure may be coated with the precious metal including platinum (Pt) and palladium (Pd) at approximately from 5 to 12 g/ft³. The reason is that when the previous metal is less than 5 g/ft³, the removal efficiency of the particulate matters (soot) is reduced and the regeneration efficiency of the diesel particulate filter 20 is reduced, and when the previous metal is more than 12 g/ft³, manufacturing costs are excessively increased.

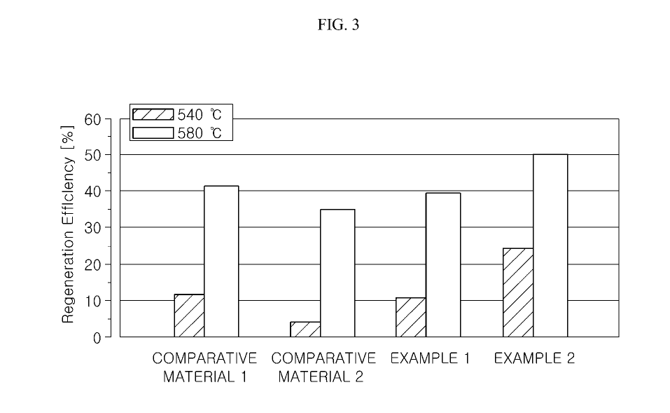

FIG. 3 is a graph illustrating regeneration efficiency depending on temperature, for the existing diesel particulate filter and examples of the present disclosure. A comparative material 1 and a comparative material 2 each are a commercial diesel particulate filter (DPF) of a channel 5 and a commercial diesel particulate filter (PDF) of a channel 6 and Example 1 is the diesel particulate filter (DPF) to which the oxidation catalyst coating layer according to the exemplary embodiment of the present disclosure is applied, and Example 2 is the diesel particulate filter (DPF) in which the oxidation catalysts coating layer according to the exemplary embodiment of the present disclosure is applied with the precious metal coating layer.

As illustrated in FIG. 3, the exemplary embodiment of the present disclosure may show the regeneration efficiency which is equal to or more than that of the existing comparative material at a low temperature less than 600° C.

In particular, it may be appreciated that Example 2 in which the precious metal coating layer 200 is stacked in the first purifier 21 has the regeneration efficiency of about 50% at 580° C., and therefore is more improved by about 20% than the comparative material 1 having the regeneration efficiency of about 42% and more improved by about 40% than the comparative material 2 having the regeneration efficiency of about 35%.

Further, it may be appreciated that Example 2 has the regeneration efficiency of about 24% at 540° C. and therefore is more improved by about 100% than the comparative material 1 having the regeneration efficiency of about 12% and more improved by about 600% than the comparative material 2 having the regeneration efficiency of about 4%.

Therefore, it may be appreciated that the diesel particulate filter 20 according to the exemplary embodiment of the present disclosure has the regeneration efficiency higher than that of the existing diesel particulate filter (DPF).

According to the exemplary embodiments of the present disclosure, it is possible to easily remove the particulate matters (soot) even at the temperature of 600° C. or less by the diesel particulate filter (DPF) of the diesel vehicle and oxidize and remove the carbon monoxide (CO) and the hydrocarbon (HC).

Further, it is possible to reduce the hydrogen sulfide (H₂S) emitted into the atmosphere by improving the purification efficiency of the hydrogen sulfide (H₂S).

As described above, although the present disclosure has been described with reference to the exemplary embodiments thereof, those skilled in the art will appreciate that various modifications and alteration may be made without departing from the scope and spirit of the present disclosure as disclosed in the accompanying claims.

What is claimed is:

1. A post-processing system of a diesel vehicle configured to reduce a hydrogen sulfide (H₂S) in an exhaust gas from an engine, the post-processing system comprising:
a lean NOₓ trap (LNT) catalyst configured to adsorb nitrogen oxide (NOₓ) under lean atmosphere and desorb the nitrogen oxide (NOₓ) under rich atmosphere, based on a window of theoretical air-fuel ratio; and
a diesel particulate filter (DPF) comprising:
a first purifier disposed at a back end of the LNT catalyst and configured to purify hydrocarbon (HC) and carbon monoxide (CO); and
a second purifier disposed at a back end of the first purifier and configured to purify hydrogen sulfide (H₂S).

2. The post-processing system according to claim 1, wherein the LNT catalyst and the DPF are sequentially disposed in a flow direction of the exhaust gas on an exhaust gas channel of the engine.

3. The post-processing system according to claim 1, wherein the diesel particulate filter has a front surface coated with an oxidation catalyst coating layer including manganese (Mn) and aluminum (Al).

4. The post-processing system according to claim 3, wherein the oxidation catalyst coating layer further includes platinum (Pt).

5. The post-processing system according to claim 3, wherein the first purifier further includes a precious metal coating layer of which a front surface is coated with a precious metal in which platinum (Pt) and palladium (Pd) are mixed at a weight ratio of approximately 1:1.

6. The post-processing system according to claim 5, wherein the precious coating layer is coated with the precious metal including the platinum (Pt) and the palladium (Pd) at approximately from 5 to 12 g/ft³.

7. A post-processing system of a diesel vehicle to reduce a hydrogen sulfide (H₂S) in an exhaust gas from an engine, the post-processing system comprising:
a lean NOₓ trap (LNT) catalyst configured to adsorb nitrogen oxide (NOₓ) under a lean atmosphere in which an air ratio is high in a window of theoretical air-fuel ratio and desorb the nitrogen oxide (NOₓ) under rich atmosphere in which a fuel ration is high in the window of theoretical air-fuel ratio; and
a diesel particulate filter (DPF) comprising:
a first purifier configured to purify hydrocarbon (HC) and carbon monoxide (CO), a portion of the first purifier being coated with a precious metal containing platinum (Pt) and palladium (Pd) according to a predetermined weight ratio and configured to remove particulate at a temperature less than 600° C.; and
a second purifier configured to purify hydrogen sulfide (H₂S), the first purifier being disposed between the LNT catalyst and the second purifier.

8. The post-processing system according to claim 7, the predetermined weight ratio is 1:1, and the precious metal includes at least 5 g/ft³ of the platinum (Pt) and palladium (Pd).

9. The post-processing system according to claim 7, wherein a layer of the precious metal is coated upon an oxidation catalyst coating layer of the DPF which comprises manganese (Mn) and aluminum (Al) and is configured to purify the hydrogen sulfide (H₂S).
